(19) United States
(12) Patent Application Publication
(10) Pub. No.: US 2007/0097591 A1
(43) Pub. Date: May 3, 2007

(54) STATIC ELIMINATING METHOD AND APPARATUS THEREFOR

(75) Inventors: Nobuhiro Fujiwara, Tsukuba-gun (JP); Shigeru Komoriya, Tsukuba-gun (JP); Noriaki Kusaba, Tsukuba-gun (JP); Satoshi Suzuki, Tsukuba-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SMC Corporation, Tokyo (JP)

(21) Appl. No.: 11/612,982

(22) Filed: Dec. 19, 2006

Related U.S. Application Data
(63) Continuation of application No. 10/932,158, filed on Sep. 2, 2004, now abandoned.

(30) Foreign Application Priority Data
Sep. 9, 2003 (JP) 2003-317296

(51) Int. Cl. H01H 47/00

(52) U.S. Cl. 361/220

(57) ABSTRACT

To provide a static eliminating method and apparatus therefor which applies a high voltage to one of a pair of electrode needles and earths the other thereof, and eliminates the need of an earthed ground plate. A single or several electrodes are provided, having one pair of electrode needles for individually applying positive and negative high voltages facing each other in a holding member made of insulating material. Changeover is performed in a short period between an applying status where a positive or negative high voltage is applied to one of the electrode needles and the other electrode needle is connected to the ground, and an applying status where the electrode needle which is applied the high voltage is connected to the ground and a high voltage having a reverse polarity to the high voltage is applied to the electrode needle connected to the ground, thereby performing static elimination by acting positive and negative ions generated based on high voltage of the electrode needles on the object to be static-eliminated.

### FIELD OF THE INVENTION

The present invention relates to a static eliminating method for eliminating static of various charged objects that are charged by charges having a positive polarity or negative polarity, that is, objects to be static-eliminated relating to, for example, semiconductor, and an apparatus therefor.

### DESCRIPTION OF THE RELATED ART

Conventionally, as means for bringing the charging amount of an object to be static-eliminated closer to zero, there has been known means where a DC high voltage or AC high voltage from a high voltage generating portion is applied to an electrode needle to generate corona discharging, which causes the electrode needle to output positive or negative ions to be sprayed on a charged object.

When positive and negative high voltages are applied to the electrode needle to generate positive and negative ions for static elimination, an earthed ground plate is typically provided near the electrode needle to promote ion discharging (see Japanese Patent Application Laid-open No. 2002-216995 Publication, for example). But when the ground plate is provided, the degree of freedom of the apparatus design as to the arrangement thereof is lowered, the maintenance requires many steps, and load is imposed on the maintenance since wear of the electrode needle is remarkable especially when positive and negative high voltages are applied to the single electrode needle.

Moreover, when the electrode needles to apply positive and negative high voltage thereon are at a certain distance away, since a positional deviation occurs in each region wherein ions generated around the electrode needles are spread and discharged, there is a problem of an uneven static elimination.

There is also proposed a static eliminating technique where a surface potential of the object to be static-eliminated is detected by the amount of ions discharged from the object and a voltage to be applied to the electrode needle is controlled based on the detected charging polarity and charging amount of the object (see Japanese Patent Application Laid-Open No. 11-345697 Publication, for example).

However, in many cases, a sensor for detecting the charging polarity or the charging amount of an object to be static-eliminated is positioned far away from the object in the conventional static eliminating apparatus. In this case, the charging polarity and the charging amount of the object to be static-eliminated are difficult to accurately detect and there occurs a problem that ions cannot be generated in the electrode needle according to the charging polarity and the charging amount of the object to be static-eliminated so that a solution therefor is desired.

### SUMMARY OF THE INVENTION

It is a technical object of the present invention to provide a static eliminating method and apparatus therefor which eliminates the need to arrange an earthed ground plate near the electrode needle thereby providing the degree of freedom of the design of the static eliminating apparatus and facilitating the manufacture and maintenance thereof.

It is another technical object of the present invention to provide a static elimination method and apparatus therefor which a positional deviation does not occur in regions wherein generated ions are spread and discharged despite of using an electrode needles on which positive and negative high voltage is applied, thereby preventing an uneven static elimination.

It is another technical object of the present invention to provide a static eliminating method and apparatus therefor which ignores charging which does not reach a threshold value in an object to be static-eliminated or charging which is lowered to the threshold or less due to static elimination to possibly reduce a time for the static eliminating processing.

It is another technical object of the present invention to provide a static eliminating method and apparatus therefor which improves loss in energy in a high voltage circuit while minimizing wear of the electrode needle, achieves energy saving, and prolongs the maintenance period thereby reducing the number of maintenance steps by utilizing one pair of electrode needles which are applied positive and negative voltages, as compared with the case where one electrode needle is used for being applied both positive and negative high voltages.

It is another object of the present invention to provide a static eliminating method and apparatus therefor where a sensor for detecting the charging polarity or the charging amount of an object to be static-eliminated is positioned near the object to accurately detect the charging polarity and the charging amount of the object to be static-eliminated.

A first static eliminating method according to the present invention for solving the above objects is constituted so that wherein a single or several electrodes, where one pair of electrode needles is faced each other which are individually applied positive and negative high voltages, are provided in a holding member made of insulating material; changeover is performed in a short period between an applying status where a positive or negative high voltage is applied to one of the electrode needles and the other electrode needle is connected to the ground, and an applying status where the electrode needle which is applied the high voltage is connected to the ground and a high voltage having a reverse polarity to the high voltage is applied to the electrode needle connected to the ground; and positive and negative ions generated based on the high voltage of the electrode needle is acted on the object to be static-eliminated to perform static elimination.

To achieve the above-mentioned object, a second static eliminating method of the present invention is constituted so that wherein a single or several electrodes, where one pair of electrode needles is faced each other which are individually applied positive and negative high voltages, are provided in a holding member made of insulating material, a sensor positioned near the object to be static-eliminated detects the charging polarity and the charging amount of the object, and when the charging amount exceeds a preset threshold value, a high voltage is applied to an electrode needle which is applied a high voltage having a reverse polarity to the charging polarity, and the other electrode needle is connected to the ground, so that positive or negative ions are generated based on the high voltage of the electrode needle to static-eliminate the object, and when the sensor detects that the charging amount reaches the threshold value or less, the application of the high voltage is discontinued, or the charging amount of the object is lowered through the controlling of a voltage to be applied to the electrode needle.

In a preferred embodiment of a second static eliminating method, when the sensor detects that the charging amount reaches the threshold value or less, a controlled voltage for restricting reverse charging is applied to one electrode needle opposite to the other electrode needle which is applied a high voltage.

In a preferred embodiment of the first and the second static eliminating method, static elimination is performed by providing an air blowout bore for blowing out airflow against the object to be static-eliminated between a pair of electrode needles faced each other, so that high voltage is applied to the electrode needle while airflow is blown out from the air blowout bore.

A first static eliminating apparatus according to the present invention for solving the above objects includes a single or several electrodes, where one pair of electrode needles is faced each other which are individually applied positive and negative high voltages, being provided in a holding member made of insulating material, and a controller to control voltage to be applied on the electrode needle; the controller controls changeover in a short period between an applying status where a positive or negative high voltage is applied to one of the electrode needles and the other electrode needle is connected to the ground, and an applying status where the electrode needle which is applied the high voltage is connected to the ground and a high voltage having a reverse polarity to the high voltage is applied to the electrode needle connected to the ground.

Further, a second static eliminating method according to the present invention for solving the above objects comprises a single or several electrodes, where one pair of electrode needles is faced each other which are individually applied positive and negative high voltages, being provided in a holding member made of insulating material, a sensor positioned near the object to be static-eliminated for detecting the charging polarity and the charging amount of the object, and a controller for controlling a voltage to be applied to the electrode needles based on an output from the sensor, wherein when the charging amount of the object to be static-eliminated, which is detected by the sensor, exceeds a preset threshold value, the controller applies a high voltage to the electrode needle which is applied the high voltage having a reverse polarity to the charging polarity, and connects the other electrode needle to the ground, to generate positive or negative ions for static elimination based on the high voltage of the electrode needle, and when the sensor detects that the charging amount reaches the threshold value or less, discontinues the application of the high voltage or controls a voltage to be applied to the electrode needle in order to reduce the charging amount.

In a preferred embodiment of the first and the second static eliminating method, there is provided an air blowout bore for blowing out airflow against the object to be static-eliminated between the pair of electrode needles faced each other, so that airflow is blown out therefrom.

As in the first and the second static eliminating method and the apparatus having above construction, when a pair of positive and negative electrode needles is faced each other, a high voltage is applied to one electrode needle, and the other electrode needle is connected to the ground to be utilized as an earth, a high voltage is applied to the electrode needle to efficiently generate positive or negative ions while eliminating the need to arrange the earthed ground plate, thereby performing static elimination.

As a result, the degree of freedom of the apparatus design as to the arrangement of the electrode needles and the like is increased. Further, since the positive and negative high voltages are individually applied to the positive and negative electrode needles, wear of the electrodes is minimized, the maintenance period is prolonged, and the ground plate is eliminated so that the number of maintenance steps can be remarkably reduced.

Since one pair of electrode needles for being applied positive and negative high voltages is employed, loss in energy in the high voltage circuit is also improved and energy saving can be achieved as compared with the case where one electrode needle is used for being applied both positive and negative high voltages.

Moreover, although using the electrode needles on which positive and negative high voltages are applied, since positive or negative ions are always generated between the electrode needles, a positional deviation does not occur in regions wherein the generated ions are spread and discharged, thereby preventing an uneven static elimination.

Further, in the second static method and apparatus therefor having the above structure, when the charging amount of the object, which is detected by the sensor, exceeds the preset threshold value, the controller applies a high voltage having a polarity (positive) reverse to the detected charging polarity (for example, negative) to a first electrode needle in one pair of faced electrode needles, and connects a second electrode needle to the ground. When the detected charging polarity is reverse (positive) to the above polarity, the controller applies a negative high voltage to the second electrode needle, and connects the first electrode needle to the ground, so that positive or negative ions are generated based on the high voltage of the electrode needle to perform static elimination on the object. When the sensor detects that the charging amount reaches the threshold value or less, the application of the high voltage is discontinued, or a controlled voltage for restricting the reverse charging is applied to the opposite electrode needle to the electrode needle which is applied a high voltage, and the charging amount of the object is reduced without being reversely charged.

In the static elimination, the threshold value is set to an appropriate value required for the object to be static-eliminated so that charging which does not reach the threshold value in the object to be static-eliminated or charging which is lowered to the threshold value or less due to static elimination is ignored to possibly reduce a time for the static eliminating processing.

Since the sensor for detecting the charging polarity or the charging amount is positioned near the object to be static-eliminated so as to accurately detect the charging polarity and the charging amount of the object to be static-eliminated, a high voltage having a reverse polarity to the charged object is applied to a dedicated electrode needle by the feedback of the output from the sensor, which enables rapid and accurate static elimination. In addition, since only either positive or negative ions are discharged, the ions easily reach even in the long distance, and the degree of freedom can be given to the installation of the electrode needles.

### BRIEF DESCRIPTION OF THE DRAWINGS

FIG. 1 is a configuration diagram showing an embodiment of a static eliminating apparatus according to the present invention;

FIG. 2 is an enlarged sectional view showing a structure of an electrode needle according to the embodiment; and

FIG. 3 is a flowchart for explaining control of the static elimination according to the present invention.

### DETAILED DESCRIPTION OF THE EMBODIMENT

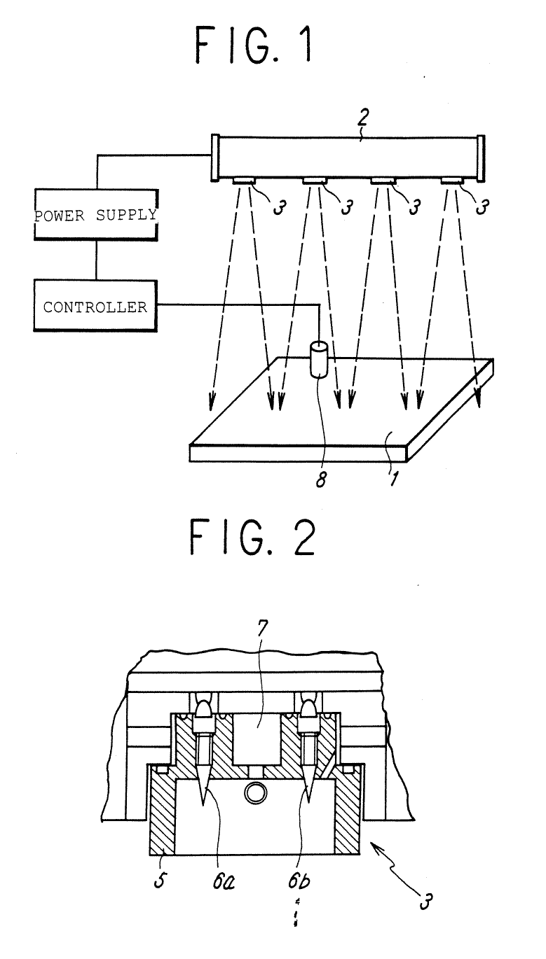

FIGS. 1 and 2 show a structure of a static eliminating apparatus according to the present invention.

The static eliminating apparatus comprises an electrode unit 2 where a plurality of electrodes 3 are faced to an object 1 to be static-eliminated which is carried along the carrying line. The electrodes 3 may be a single electrode, but as illustrated, several ones can be arranged in the carrying direction of the object 1 to be static-eliminated or in a direction perpendicular thereto.

The electrode 3 is constituted so that one pair of electrode needles 6a and 6b is faced each other where positive and negative high voltages are individually applied to a holding member 5 made of insulating material as shown in FIG. 2, and these electrode needles 6a and 6b are connected to a power supply, respectively. A controller to be described later controls so that a positive high voltage, for example, is applied to a first electrode needle 6a out of the electrode needles, and a negative high voltage having a reverse polarity thereto is applied to a second electrode needle 6b. Generally, one of the electrode needles is applied a high voltage, and the other electrode is connected to the ground. The electrode needle connected to the ground is maintained at the same ground level as that of a frame where the object 1 to be static-eliminated is placed.

Between the pair of the electrode needles 6a, 6b faced each other in the holding member 5, there is provided an air blowout bore to blow out an airflow against the object 1 to be static-eliminated, and is connected to an unillustrated blower or the like for blowing out the airflow. When such air blowout bore 7 is provided, the positive or negative ions generated between the pair of electrode needles 6a, 6b can be fed to the vicinity of the object 1 to be static-eliminated by the airflow from the single air blowout bore 7, thereby leading to a static elimination with high efficiency.

The static eliminating apparatus can be provided with an arbitrary means other than the air blowout bore 7 for efficiently feeding ions generated by the application of the high voltage to the electrode needle to the vicinity of the object to be static-eliminated.

The static eliminating apparatus comprises a sensor 8 positioned near the object 1 to be static-eliminated for detecting the charging polarity and the charging amount based on a surface potential of the object 1 to be static-eliminated. The sensor 8 is connected to the controller in order to control voltages to be applied to the electrode needles 6a and 6b based on the output from the sensor 8.

In the first static eliminating apparatus of the present invention, the controller controls changeover to be performed in a short period, for example, level of several tens of Hz such as 33 Hz or 22 Hz, between an applying status where a positive or negative high voltage is applied to one of the electrode needles 6a, 6b and the other electrode needle 6a, 6b is connected to the ground, and an applying status where the electrode which is applied the high voltage is connected to the ground and a high voltage having a reverse polarity to the high voltage is applied to the electrode needle connected to the ground. In this case, the sensor 8 is unnecessary.

When high voltage to be applied to the electrode needles is controlled using the controller, the positive and negative ions act upon the object to be static-eliminated. Within those ions, only the ions of reverse polarity to the charged polarity of the object to be static-eliminated are adsorbed by the object to act efficiently for static elimination. Although having slight inferiority in static eliminating speed than in case of a second static eliminating apparatus to be described hereunder, an efficient static elimination can be performed without being charged in reverse polarity.

On the other hand, in the control apparatus of the second static eliminating apparatus of the invention, when the charging amount of the object 1 to be static-eliminated, which is detected by the sensor 8, exceeds the preset threshold value, the controller applies a high voltage to the electrode needle to which the high voltage having the reverse polarity to the charging polarity is applied and connects the other electrode needle to the ground to generate positive or negative ions for static elimination based on the high voltage of the electrode needle 6a or 6b. Further, as a result of the static elimination by the ions, when the sensor 8 detects that the charging amount reaches the threshold value or less, the controller controls the power supply so as to discontinue the application of the high voltage.

For further specific explanation, when the charging amount of the object 1, which is detected by the sensor 8, exceeds the preset threshold value, the controller applies a high voltage having a reverse polarity (positive) to the detected charging polarity (for example, negative) to the first electrode needle 6a and connects the second electrode needle 6b to the ground. Further, when the detected charging polarity is reverse (positive) to the above, the controller controls so that a negative high voltage is applied to the second electrode needle 6b and the first electrode needle 6a is connected to the ground, thereby generating positive or negative ions based on the high voltage of the electrode needle 6a or 6b to perform static elimination on the object 1.

As a result of the static elimination by the generation of ions, when the sensor 8 detects that the charging amount reaches the threshold value or less, the controller controls to discontinue the application of the high voltage. The timing thereof needs to be set so as not to reversely charge the object 1 to be static-eliminated as a result of the static elimination by the high voltage applied to the electrode needle 6a or 6b, so that the control of the high voltage application in the controller can be simplified, which is effective in terms of energy saving.

There has been described that the controller controls to discontinue the current applying when the charging amount reaches the threshold value or less, but the controller can appropriately control a voltage to be applied to the electrode needle 6a or 6b in order to reduce the charging amount.

For example, in order to prevent reverse charging around the completion of the static elimination, an applied voltage is PWM-controlled from when the sensor 8 reaches a certain threshold value, or the object to be static-eliminated is possibly brought closer to the ground potential through the control such as lowering of the applied voltage, alternatively a controlled voltage for restricting the reverse charging can be applied to an opposite electrode needle to the applied electrode needle.

The threshold value which is preset for the controller can be arbitrarily adjusted.

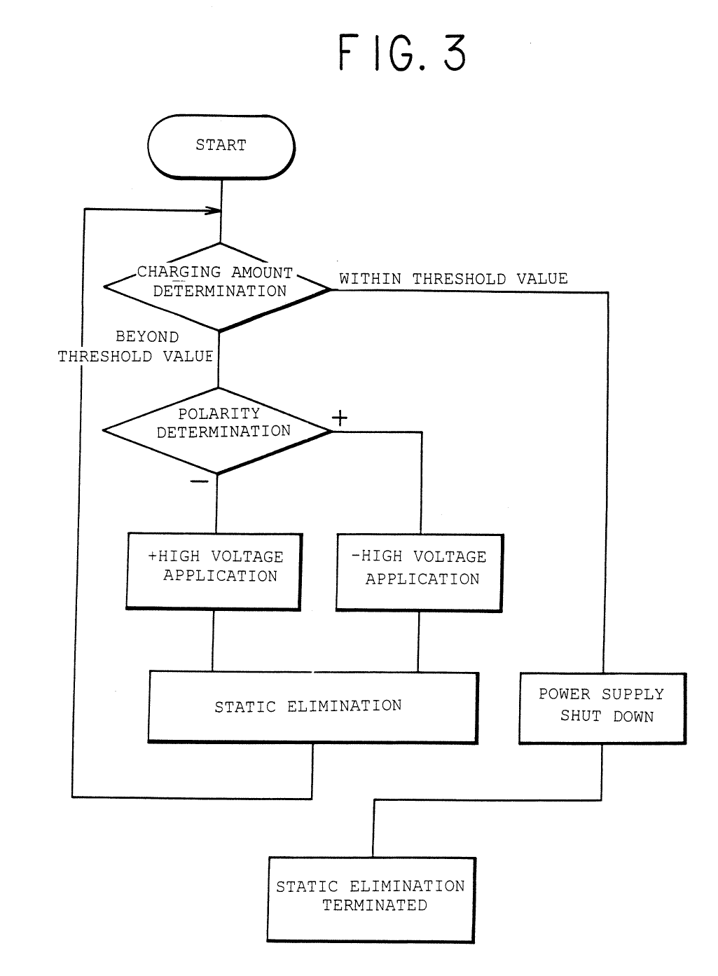

A flowchart in FIG. 3 shows how the second controller controls the static elimination. For explanation on the drawing, when the sensor 8 positioned near the object 1 to be static-eliminated detects the charging polarity and the charging amount of the object 1, the controller determines whether or not the charging amount exceeds the preset threshold value, and if it does not exceed the threshold value, terminates the static elimination. On the other hand, when the charging amount of the object 1 to be static-eliminated exceeds the threshold value, the controller determines the charging polarity and applies a high voltage having a reverse polarity to the detected charging polarity to the electrode needle 6a or 6b and connects the other electrode needle to the ground. Thus, positive or negative ions are generated based on the high voltage of the electrode needle to perform static elimination on the object 1.

The sensor 8 always detects the charging polarity and the charging amount to input the result into the controller, and when the charging amount is determined through the detection to have reached the threshold value or less, shuts down the power supply which applies the high voltage, and terminates the static elimination.

In the second static eliminating method and static eliminating apparatus, the threshold value is set at an appropriate value required for the object 1 to be static-eliminated so that charging which does not reach the threshold value in the object to be static-eliminated or charging which is lowered to the threshold value or less due to the static elimination is ignored, thereby possibly reducing a time for the static eliminating processing.

Since the sensor 8 for detecting the charging polarity and the charging amount of the object 1 to be static-eliminated is positioned near the object 1 to accurately detect the charging polarity and the charging amount of the object to be static-eliminated, a high voltage having a reverse polarity to the charged object is applied to the electrode needle by the feedback of the output from the sensor 8 so that rapid and accurate static elimination is enabled. In addition, since only either positive or negative ions are discharged, ions easily reach even in the long distance, and the degree of freedom is given to the installation of the electrode needles.

In the first and the second static eliminating method and the apparatus, since one pair of positive and negative electrode needles 6a and 6b is faced each other and a high voltage is applied to one electrode needle 6a or 6b while the other electrode needle 6a or 6b is connected to the ground thereby utilizing the electrode needle which is not applied the high voltage as an earth, positive or negative ions are efficiently generated by the application of the high voltage to the electrode needle 6a or 6b while eliminating the need to arrange the earthed ground plate, thereby performing the static elimination.

As a result, the degree of freedom of the apparatus design as to the arrangement of the electrodes 3 comprising the electrode needles 6a and 6b is increased. Further, since positive and negative high voltages are individually applied to the positive and negative electrode needles 6a and 6b, wear of the electrode needles can be minimized, the maintenance period can be prolonged, and the ground plate is eliminated so that the number of maintenance steps can be remarkably reduced.

Since one pair of electrode needles 6a and 6b to which positive and negative high voltages are applied is employed, loss in energy in the high voltage circuit can be also improved thereby achieving energy saving, as compared with the case where one electrode needle is used for being applied both positive and negative high voltages.

Moreover, although using the electrode needles on which positive and negative high voltages are applied, a positional deviation does not occur in regions wherein generated ions are spread and discharged, thereby preventing an uneven static elimination.

1. A discharging method wherein a single or several electrodes, where one pair of electrode needles is faced each other which are individually applied positive and negative high voltages, are provided in a holding member made of insulating material; changeover is performed in a short period between an applying status where a positive or negative high voltage is applied to one of the electrode needles and the other electrode needle is connected to the ground, and an applying status where the electrode needle which is applied the high voltage is connected to the ground and a high voltage having a reverse polarity to the high voltage is applied to the electrode needle connected to the ground; and positive and negative ions generated based on the high voltage of the electrode needle is acted on the object to be static-eliminated to perform static elimination.

2. A static eliminating method wherein a single or several electrodes, where one pair of electrode needles is faced each other which are individually applied positive and negative high voltages, are provided in a holding member made of insulating material; wherein a sensor positioned near the object to be static-eliminated detects the charging polarity and the charging amount of the object, and the charging amount exceeds a preset threshold value, a high voltage is applied to an electrode needle which is applied a high voltage having a reverse polarity to the charging polarity, and the other electrode needle is connected to the ground, so that positive or negative ions are generated based on the high voltage of the electrode needle to static-eliminate the object, and when the sensor detects that the charging amount reaches the threshold value or less, the application of the high voltage is discontinued or the charging amount of the object is lowered through the controlling of a voltage to be applied to the electrode needle.

3. The static eliminating method according to claim 2, wherein when the sensor detects that the charging amount reaches the threshold value or less, a controlled voltage for restricting reverse charging is applied to an opposite electrode needle to the electrode needle which is applied a high voltage.

4. The static eliminating method according to claim 1, wherein an air blowout bore for blowing out an airflow against the object to be static-eliminated is provided between a pair of electrode needles faced each other, so that high-voltage is applied to the electrode needle while the airflow is blown out from the air blowout bore to perform static elimination.

5. A static eliminating apparatus including a single or several electrodes, where one pair of electrode needles is faced each other which are individually applied positive and negative high voltages, are provided in a holding member made of insulating material, and a controller to control a voltage to be applied to the electrode needle; the controller controlling changeover in a short period between an applying status where a positive or negative high voltage is applied to one of the electrode needles and the other electrode needle is connected to the ground, and an applying status where the electrode needle which is applied the high voltage is connected to the ground and a high voltage having a reverse polarity to the high voltage is applied to the electrode needle connected to the ground.

6. A static eliminating apparatus comprising a single or several electrodes, where one pair of electrode needles is faced each other which are individually applied positive and negative high voltages, are provided in a holding member made of insulating material, a sensor positioned near the object to be static-eliminated for detecting the charging polarity and the charging amount of the object, and a controller for controlling a voltage to be applied to an electrode needle based on the output from the sensor, wherein the controller controls so that when the charging amount of the object to be static-eliminated, which is detected by the sensor, exceeds the preset threshold value, the controller applies a high voltage to an electrode needle which is applied the high voltage having a reverse polarity to the charging polarity and connects the other electrode needle to the ground to generate positive or negative ions for static elimination based on the high voltage of the electrode needle, and when the sensor detects that the charging amount reaches the threshold value or less, the controller discontinues the application of the high voltage or controls a voltage to be applied to the electrode needle in order to reduce the charging amount.

7. The static eliminating apparatus according to claim 5, wherein an air blowout bore for blowing out airflow against the object to be static-eliminated is provided between a pair of electrode needles faced each other.
